(19) United States
(12) Patent Application Publication
(10) Pub. No.: US 2026/0122412 A1
(43) Pub. Date: Apr. 30, 2026

(54) Factory Monitor

(71) Applicant: Microchip Technology Inc., Chandler, AZ (US)

(72) Inventors: Patrick McFarland, Gilbert, AZ (US); Steve Nagel, Chandler, AZ (US); Bomy Chen, Newark, CA (US); Arthur B. Eck, Gilbert, AZ (US)

(73) Assignee: Microchip Technology Inc., Chandler, AZ (US)

(21) Appl. No.: 19/237,655

(22) Filed: Jun. 13, 2025

Related U.S. Application Data
(60) Provisional application No. 63/711,506, filed on Oct. 24, 2024.

(51) Int. Cl. H04R 1/40; H04S 7/00

(52) U.S. Cl. CPC H04R 1/406; H04S 7/40

(57) ABSTRACT

A system and method are provided for monitoring a factory, comprising during a training period of time, training a machine learning model with training data including a plurality of known spectral representations each of which is designated in the training data as normal or abnormal; and during an operating period of time receiving a first audio sample from a first microphone in an array of microphones suspended above a plurality of mechanical devices, generating a first spectral representation from the first audio sample, providing the first spectral representation to the machine learning model, and determining that the first spectral representation is abnormal.

### RELATED APPLICATION

This application claims the benefit of U.S. application 63/711,506, filed on Oct. 24, 2024, and incorporates that application by reference in its entirety.

### FIELD OF THE INVENTION

Detection and/or prediction of machine faults.

### BACKGROUND

Factories and other industrial facilities often have large numbers of mechanical devices that eventually require maintenance and repair. Downtime for factories can be very expensive as production is idled, consumables may spoil, machines may need to be cleared, and input supplies may accumulate beyond local storage facilities.

### SUMMARY

In some examples, a method is provided for monitoring a factory, comprising during a training period of time, training a machine learning model with training data including a plurality of known spectral representations each of which is designated in the training data as normal or abnormal; and, during an operating period of time, receiving a first audio sample from a first microphone in an array of microphones suspended above a plurality of mechanical devices, generating a first spectral representation from the first audio sample, providing the first spectral representation to the machine learning model, and determining that the first spectral representation is abnormal. In certain examples, the method comprises, during a subsequent training period of time, receiving a second audio sample from the first microphone, generating a second spectral representation from the second audio sample, training the machine learning model with the second spectral representation designated as normal. In some examples, the method comprises, during the operating period of time, capturing a left audio sample from a left directional microphone mounted in a handheld device, generating a left spectral representation of the left audio sample, capturing a center audio sample from a center directional microphone mounted in the handheld device, generating a center spectral representation of the center audio sample, capturing a right audio sample from a right directional microphone mounted in the handheld device, generating a right spectral representation of the right audio sample, determining that at least one of the left, center, and right spectral representations matches the first spectral representation, and visually indicating on the handheld device which of the left, center, and right spectral representations that match the first spectral representation. In certain examples, the method comprises, during the training period of time, coupling a vibration sensor to a specific mechanical device under the array of microphones, generating a second spectral representation from the vibration sensor, and generating a training data record including the second spectral representation and a normal designation. In certain examples, the method comprises, during a subsequent training period of time, training the machine learning model with the first spectral representation designated as normal. In certain examples, the method comprises, during a setup period of time, cloning the trained machine learning model to provide a unique trained machine learning model for each microphone in the array of microphones. In certain examples, the method comprises, during an operating period of time, receiving a second audio sample from a second microphone in the array of microphones suspended above a plurality of mechanical devices, generating a second spectral representation from the second audio sample, providing the second spectral representation to the machine learning model, and determining that the second spectral representation is abnormal.

In some examples, a non-transitory computer readable memory comprising instructions that when executed on a processor, during a training period of time, train a machine learning model with training data including a plurality of known spectral representations each of which is designated in the training data as normal or abnormal; and, during an operating period of time, receive a first audio sample from a first microphone in an array of microphones suspended above a plurality of mechanical devices, generate a first spectral representation from the first audio sample, provide the first spectral representation to the machine learning model, and determine that the first spectral representation is abnormal. In certain examples, the non-transitory computer readable memory comprises instructions that when executed on a processor, during a subsequent training period of time, receive a second audio sample from the first microphone, generate a second spectral representation from the second audio sample, and train the machine learning model with the second spectral representation designated as normal. In certain examples, the non-transitory computer readable memory comprises instructions that when executed on a processor, during the operating period of time, capture a left audio sample from a left directional microphone mounted in a handheld device, generate a left spectral representation of the left audio sample, capture a center audio sample from a center directional microphone mounted in the handheld device, generate a center spectral representation of the center audio sample, capture a right audio sample from a right directional microphone mounted in the handheld device, generate a right spectral representation of the right audio sample, determine that at least one of the left, center, and right spectral representations matches the first spectral representation, and visually indicate on the handheld device which of the left, center, and right spectral representations that match the first spectral representation. In certain examples, the non-transitory computer readable memory comprises instructions that when executed on a processor, during the training period of time, generate a second spectral representation from a vibration sensor coupled to a specific mechanical device under the array of microphones, and generate a training data record including the second spectral representation and a normal designation. In certain examples, the non-transitory computer readable memory comprises instructions that when executed on a processor, during a subsequent training period of time, train the machine learning model with the first spectral representation designated as normal. In certain examples, the non-transitory computer readable memory comprises instructions that when executed on a processor, during a setup period of time, clone the trained machine learning model to provide a unique trained machine learning model for each microphone in the array of microphones. In certain examples, the non-transitory computer readable memory comprises instructions that when executed on a processor, during an operating period of time, receive a second audio sample from a second microphone in the array of microphones suspended above a plurality of mechanical devices, generate a second spectral representation from the second audio sample, provide the second spectral representation to the machine learning model, and determine that the second spectral representation is abnormal.

In some examples, a system is provided comprising a plurality of microphones arranged in an array above an industrial facility including a plurality of installed machines, the array of microphones providing partially overlapping pickup patterns covering each of the machines, a computer processor to receive audio from the each of the plurality of microphones and to a non-transitory computer readable memory comprising instructions that when executed on the processor, during a training period of time, train a machine learning model with training data including a plurality of known spectral representations each of which is designated in the training data as normal or abnormal; and during an operating period of time, receive a first audio sample from a first microphone in an array of microphones suspended above a plurality of mechanical devices, generate a first spectral representation from the first audio sample, provide the first spectral representation to the machine learning model, and determine that the first spectral representation is abnormal. In certain examples, the non-transitory computer readable memory comprises instructions that when executed on a processor, during a subsequent training period of time, receive a second audio sample from the first microphone, generate a second spectral representation from the second audio sample, train the machine learning model with the second spectral representation designated as normal. In certain examples, the system comprises a handheld device including a left directional microphone, a center directional microphone, and a right directional microphone, the non-transitory computer readable memory comprising instructions that when executed on the processor: during the operating period of time, capture a left audio sample from the left directional microphone, generate a left spectral representation of the left audio sample, capture a center audio sample from the center directional microphone, generate a center spectral representation of the center audio sample, capture a right audio sample from the right directional microphone mounted in the handheld device, determine that at least one of the left, center, and right spectral representations matches the first spectral representation, and visually indicate on the handheld device which of the left, center, and right spectral representations that match the first spectral representation. In certain examples, the system comprises a vibration sensor coupled to a specific mechanical device under the array of microphones; the non-transitory computer readable memory comprising instructions that when executed on the processor, during the training period of time, generate a second spectral representation from the vibration sensor, and generate a training data record including the second spectral representation and a normal designation. In certain examples, the non-transitory computer readable memory comprises instructions that when executed on a processor, during a second training period of time train the machine learning model with the first spectral representation designated as normal. In certain examples, the non-transitory computer readable memory comprises instructions that when executed on a processor, the non-transitory computer readable memory comprising instructions that when executed on the processor, during a setup period of time, clone the trained machine learning model to provide a unique trained machine learning model for each microphone in the array of microphones.

### BRIEF DESCRIPTION OF THE FIGURES

FIG. 1 illustrates a method for monitoring equipment in a facility, according to certain examples.

FIG. 2 illustrates a fixed arrangement of microphones for monitoring equipment in a factory, according to certain examples.

FIG. 3 illustrates a fixed arrangement of microphones for monitoring equipment in a factory and a portable microphone, according to certain examples.

FIG. 4 illustrates a system for monitoring equipment in a facility including an attachable sensor, according to certain examples.

### DETAILED DESCRIPTION

Factory equipment often changes sound when some part requires maintenance or has failed in some way. For example, a rotary device may include ball bearings to reduce internal friction. Over time one or more bearing may begin to wear due to insufficient lubrication or introduction of contaminants like dust, sand, or metal shavings. A worn bearing may begin to make a sound of a different pitch or may make a repeating sound as that bearing works its way to a load position. If the worn bearings are not lubricated or replaced, they will wear further and eventually fail. Bearing failure can increase the load on a driving motor, strain on belts or transmissions coupled to the motor, or can even seize up thus preventing operation of the equipment, By detecting the abnormal sound signature when the bearings first begin to wear, an operator may be alerted and maintenance may be scheduled to lubricate or replace the bearings.

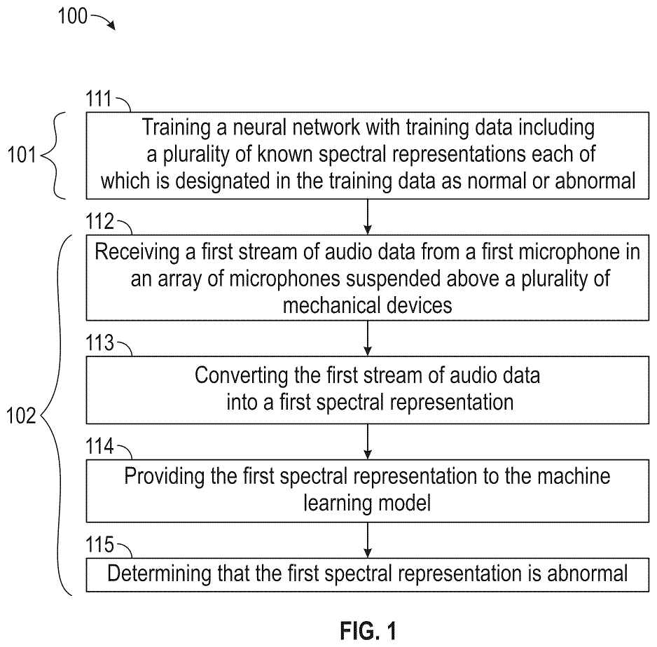

FIG. 1 illustrates a method for monitoring equipment in a facility, according to certain examples. Method 100 includes two modes of operation including training mode 101 and operational mode 102. In training mode 101 and at block 111, a factory monitoring system may feed training data into a machine learning model in the form of spectral representations of known normal equipment sounds along with an indicator that the spectra represent normal operation. The machine learning model may be a neural network. For example, software may capture sound from a normally operating pick and place machine, translate that sound into a spectral representation, and feed that spectral representation into a machine learning model along with an indicator that the spectral representation is normal. In some examples, the spectral representation may be in the form of an image that may be fed into a convolutional neural network (CNN). In some examples, the spectral representation may be an array of data that may be fed into a recurrent neural network (RNN) or a long short-term memory (LSTM) neural network. The selection of a neural network algorithm may depend on the types of anomalies (which signal a need for maintenance or repair) anticipated in a particular environment. In some examples, a spectral representation at a single point in time may capture anomalies relevant to a particular type of equipment. In some examples, a spectral representation over time may capture the anomaly or may be necessary to characterize the anomaly. In some examples, training data may be provided in the form of a library of known normal spectral representations for types of equipment in a particular environment. For example, a training library for a commercial bakery might include data representing the operation of mixers, ovens, sheeters, and pastry presses. In another example, a training library for a semiconductor assembly facility may include data representing stencil printers, pick and place machines, reflow soldering machines, dry boxes, counters and rework stations. In some examples, a factory may be replicated in a new location with standardized equipment and the neural network may be trained at one location (or based on a library of equipment sounds) and delivered pre-trained to the new location.

In some examples, a training library may include data representing known abnormal sounds designated as abnormal. For example, abnormal sounds may include: a crunched ball bearing in a rotating machine, the sound of a snapped transmission belt, a gunshot, an explosion, fire, spraying water, breaking glass, the sound of a cigarette lighter, or the squeak of a mouse.

In operating mode 102, an array of microphones may be installed suspended from the ceiling (or other raised structure) above equipment to be monitored. At block 112, the factory monitoring system may receive a first stream of audio data from a first microphone of the array of microphones suspended above the plurality of mechanical devices. The microphone may be a directional microphone aimed downward. In some examples, the microphone may be housed with a resonance chamber that is tuned to the anticipated sounds of the monitored equipment. In some examples, the microphone may be a cluster of microphones, each having a different tuned resonance chamber. In some examples, the microphone may be a system of microphones, some of which may be housed in tuned resonance chambers. At block 113, the factory monitoring system may convert the first stream of audio data into a first spectral representation. In some examples, this spectral representation may be a graphical representation such as a spectrogram or a scalogram. At block 114, the first spectral representation is provided to the machine learning model. At block 115, the machine learning model determines that the first spectral representation is abnormal.

In some examples, an operator may determine the equipment is operating normally and may reenter training mode 101 and enter the first spectral representation with a normal operation indicator.

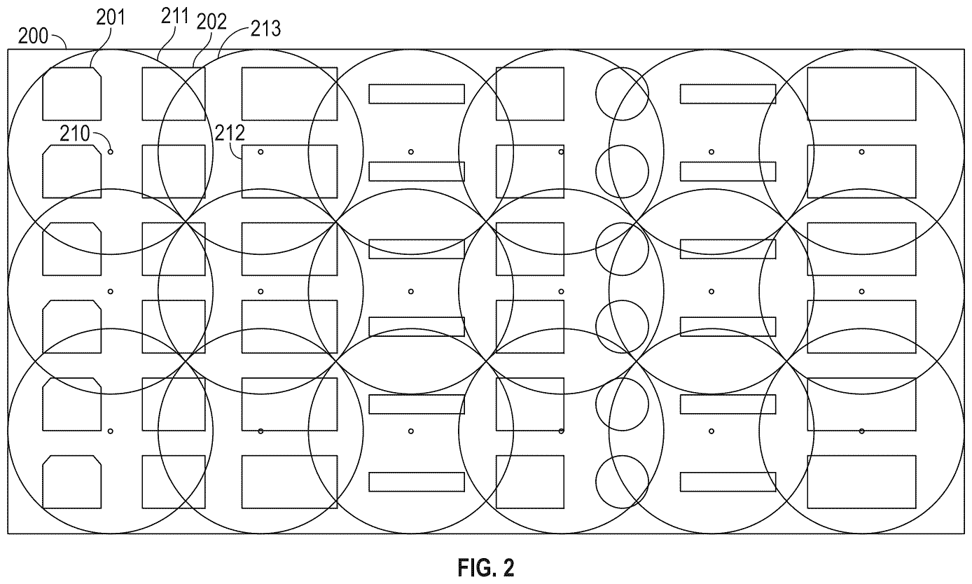

FIG. 2 illustrates a fixed arrangement of microphones for monitoring equipment in a factory, according to certain examples. In some examples, area 200 may be a factory space with various machines to be monitored, including machines 201 and 202. An array of microphones, including microphones 210 and 212, may be installed above the equipment. In some examples, microphones 210 and 212 may be installed in a drop ceiling grid. In some examples, microphones 210 and 212 may be suspended from the ceiling structure. In some examples, area 200 may be an outdoor area and microphones 210 and 212 may be attached to one or more elevated wires. Microphone 210 may be a directional microphone with an audio pick-up area 211. Microphone 212 may be a directional microphone with an audio pick-up area 213. Microphones 210 and 212 may be arranged to have partially overlapping pickup areas 211 and 213.

In some examples, machine 201 may be making an abnormal sound. Because machine 210 is within pickup area 211, microphone 210 may capture audio including that abnormal sound and when a spectral representation of audio is processed by the machine learning model, the machine learning algorithm may report the presence of an abnormal sound corresponding to the audio feed from microphone 210. An operator may then be notified to report to the location within area 200 that corresponds to pickup area 211. The operator may then determine whether the abnormal sound indicates some type of fault or maintenance condition.

In some examples, machine 202 may be making an abnormal sound. Because machine 202 is at least partially within pickup areas 211 and 213, Microphones 210 and one other have pick-up areas covering machine 202. The monitoring server may generate a spectral representation for each of the microphones and process those spectral representations through a machine learning model. The machine learning model may report the presence of an abnormal sound corresponding to the audio feeds from both microphones 210 and 212. An operator may then be notified to report to the location within area 200 that corresponds to the overlap of pickup areas 211 and 213. The operator may then determine whether the abnormal sound indicates some type of fault or maintenance condition.

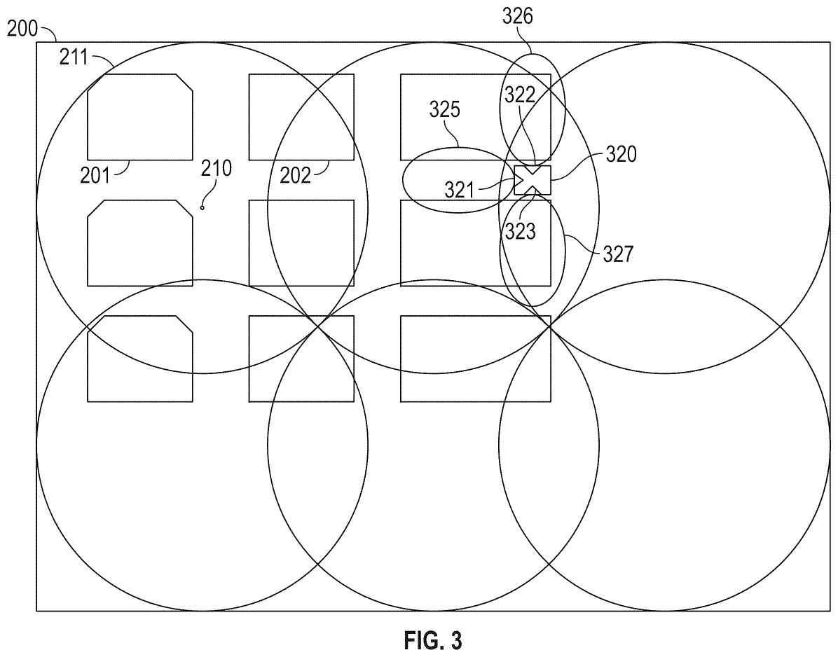

FIG. 3 illustrates a fixed arrangement of microphones for monitoring equipment in a factory and a portable audio capture device, according to certain examples. In these examples, a machine in area 200 may be generating an abnormal sound as identified by, for example, processing a spectral representation of audio captured at ceiling-mounted microphone 210. An operator may be dispatched to area 200 with portable audio capture device 320 to more precisely locate the source of the abnormal sound. Portable audio capture device 320 may include directional microphone 321 (with audio capture area 325) for capturing audio as the operator walks through area 200. In some examples, portable audio capture device 320 may include onboard processing and a copy of the common machine learning model used to identify the abnormal sound captured by microphone 210. In some examples, portable audio capture device 320 may include a wireless communication link to a computer to process audio captured by directional microphone 321. Portable audio capture device may include a user interface to indicate whether audio captured by directional microphone 321 is normal or abnormal, according to the machine learning model. The user interface may be haptic feedback (a controlled vibration), a red/green light, or a graphical display, in some examples. The operator may then walk through area 200 looking for an indication that an abnormal sound has been identified. The operator may point directional microphone 321 at specific machines to determine which machine is producing the abnormal sound.

In some examples, portable audio capture device may include additional microphone 322 (with audio capture area 326) and microphone 323 (with audio capture area 327). In some examples, audio capture areas 326 and 327 may not overlap with audio capture area 325. In some examples, audio capture areas 326 and 327 may partially overlap with audio capture area 325. These additional audio capture areas may be accompanied by corresponding user interface elements. In an example, microphones 321, 322, and 323 may be mounted on the front and two sides of portable audio capture device 320 along with corresponding lights. If lights corresponding to 321 and 322 indicate the abnormal noise and 323 does not, the noise may be to the right of the operator holding the device with microphone 321 furthest from her person.

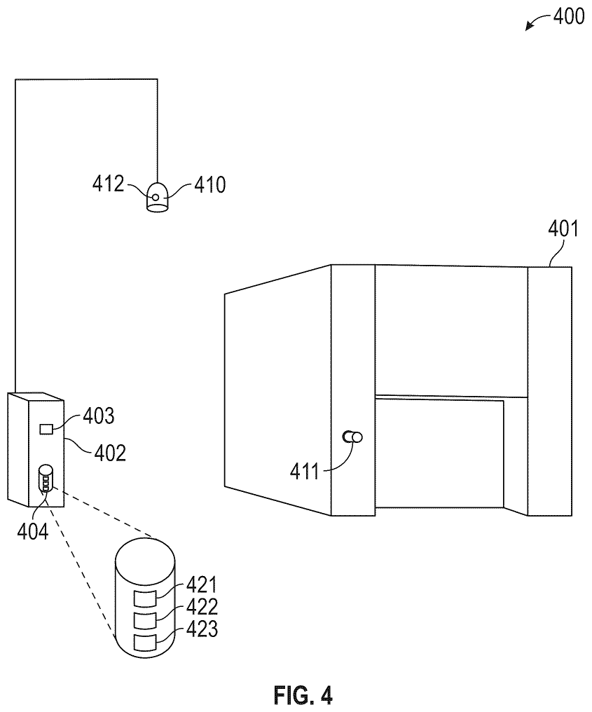

FIG. 4 illustrates a system for monitoring equipment in a facility including an attachable sensor, according to certain examples. In some examples, area 400 may include machine 401 within an audio pickup region of directional microphone 410. Directional microphone may be incorporated into a housing to shape the pickup area for that microphone. For example, the housing may shield microphone 410 from audio sources above the horizontal plane of the microphone to avoid capturing sounds from air conditioning ducts mounted between the ceiling and the microphones or air conditioning units installed on the roof of the building. Audio from directional microphone 410 may be captured by computer 402 that includes processor 403 and non-transitory computer readable media 404. Processor 403 may be an x86 compatible processor, in some examples. Non-transitory computer readable media 404 may be a flash drive, in some examples. Non-transitory computer readable media 404 may store instructions 421 that, when executed on processor 403, perform the methods of this disclosure including the method illustrated in FIG. 1. Non-transitory computer readable media 404 may include machine learning algorithm 422 including instructions that when executed on processor 403 load machine learning database 423 to form a trained machine learning model. In some examples, machine learning algorithm 422 may be a Bayes algorithm. In some examples, machine learning algorithm 422 may be a neural network algorithm. In some examples, machine learning database 423 may be generated by computer 402 based on training audio samples generated within area 400. In some examples, machine learning database 423 may be generated at another facility with the same types of equipment and loaded into computer 402. In some examples, machine learning database 423 may be generated based on one or more training data sets provided by equipment manufacturers.

In some examples, an operator may wish to more precisely sample vibrations from a specific machine either for training purposes or to isolate an abnormal sound. The operator may affix vibration probe 411 to machine 401. In some examples, vibration probe 411 includes a microphone and a magnetic housing to securely attach to machine 401. In some examples, vibration probe 411 may include a wireless transmitter for transmitting audio data to computer 401. In some examples, vibration probe 411 may include a processor and a non-transitory computer readable memory containing instructions for generating a spectral analysis of audio captured by the microphone. In some examples, a sound deadening blanket may be used to cover machine 401 during observation to isolate machine 401 from other sounds or vibrations.

Although examples have been described above, other variations and examples may be made from this disclosure without departing from the spirit and scope of these examples.

We claim:

1. A method for monitoring a factory, comprising:
during a training period of time, training a machine learning model with training data including a plurality of known spectral representations each of which is designated in the training data as normal or abnormal; and
during an operating period of time:
receiving a first audio sample from a first microphone in an array of microphones suspended above a plurality of mechanical devices,
generating a first spectral representation from the first audio sample,
providing the first spectral representation to the machine learning model, and
determining that the first spectral representation is abnormal.

2. The method of claim 1, comprising:
during a subsequent training period of time:
receiving a second audio sample from the first microphone,
generating a second spectral representation from the second audio sample,
training the machine learning model with the second spectral representation designated as normal.

3. The method of claim 1, comprising:
during the operating period of time:
capturing a left audio sample from a left directional microphone mounted in a handheld device, generating a left spectral representation of the left audio sample,
capturing a center audio sample from a center directional microphone mounted in the handheld device, generating a center spectral representation of the center audio sample,
capturing a right audio sample from a right directional microphone mounted in the handheld device, generating a right spectral representation of the right audio sample,
determining that at least one of the left, center, and right spectral representations matches the first spectral representation, and
visually indicating on the handheld device which of the left, center, and right spectral representations that match the first spectral representation.

4. The method of claim 1, comprising:
during the training period of time:
coupling a vibration sensor to a specific mechanical device under the array of microphones,
generating a second spectral representation from the vibration sensor, and
generating a training data record including the second spectral representation and a normal designation.

5. The method of claim 1, comprising:
during a subsequent training period of time:
training the machine learning model with the first spectral representation designated as normal.

6. The method of claim 1, comprising:
during a setup period of time:
cloning the trained machine learning model to provide a unique trained machine learning model for each microphone in the array of microphones.

7. The method of claim 1, comprising:
during an operating period of time:
receiving a second audio sample from a second microphone in the array of microphones suspended above a plurality of mechanical devices,
generating a second spectral representation from the second audio sample,
providing the second spectral representation to the machine learning model, and
determining that the second spectral representation is abnormal.

8. A non-transitory computer readable memory comprising instructions that when executed on a processor:
during a training period of time, train a machine learning model with training data including a plurality of known spectral representations each of which is designated in the training data as normal or abnormal; and
during an operating period of time:
receive a first audio sample from a first microphone in an array of microphones suspended above a plurality of mechanical devices,
generate a first spectral representation from the first audio sample,
provide the first spectral representation to the machine learning model, and
determine that the first spectral representation is abnormal.

9. The non-transitory computer readable memory of claim 8, comprising instructions that when executed on a processor:
during a subsequent training period of time:
receive a second audio sample from the first microphone,
generate a second spectral representation from the second audio sample, and
train the machine learning model with the second spectral representation designated as normal.

10. The non-transitory computer readable memory of claim 8, comprising instructions that when executed on a processor:
during the operating period of time:
capture a left audio sample from a left directional microphone mounted in a handheld device, generate a left spectral representation of the left audio sample,
capture a center audio sample from a center directional microphone mounted in the handheld device, generate a center spectral representation of the center audio sample,
capture a right audio sample from a right directional microphone mounted in the handheld device, generate a right spectral representation of the right audio sample,
determine that at least one of the left, center, and right spectral representations matches the first spectral representation, and
visually indicate on the handheld device which of the left, center, and right spectral representations that match the first spectral representation.

11. The non-transitory computer readable memory of claim 8, comprising instructions that when executed on a processor:
during the training period of time:
generate a second spectral representation from a vibration sensor coupled to a specific mechanical device under the array of microphones, and
generate a training data record including the second spectral representation and a normal designation.

12. The non-transitory computer readable memory of claim 8, comprising instructions that when executed on a processor:
during a subsequent training period of time:
train the machine learning model with the first spectral representation designated as normal.

13. The non-transitory computer readable memory of claim 8, comprising instructions that when executed on a processor:
during a setup period of time:
clone the trained machine learning model to provide a unique trained machine learning model for each microphone in the array of microphones.

14. The non-transitory computer readable memory of claim 8, comprising instructions that when executed on a processor:
during an operating period of time:
receive a second audio sample from a second microphone in the array of microphones suspended above a plurality of mechanical devices,
generate a second spectral representation from the second audio sample,
provide the second spectral representation to the machine learning model, and
determine that the second spectral representation is abnormal.

15. A system comprising:
a plurality of microphones arranged in an array above an industrial facility including a plurality of installed machines, the array of microphones providing partially overlapping pickup patterns covering each of the machines,
a computer processor to receive audio from the each of the plurality of microphones and to a non-transitory computer readable memory comprising instructions that when executed on the processor:
during a training period of time, train a machine learning model with training data including a plurality of known spectral representations each of which is designated in the training data as normal or abnormal; and
during an operating period of time:
receive a first audio sample from a first microphone in an array of microphones suspended above a plurality of mechanical devices,
generate a first spectral representation from the first audio sample,
provide the first spectral representation to the machine learning model, and
determine that the first spectral representation is abnormal.

16. The system of claim 15, the non-transitory computer readable memory comprising instructions that when executed on the processor:
during a subsequent training period of time:
receive a second audio sample from the first microphone,
generate a second spectral representation from the second audio sample,
train the machine learning model with the second spectral representation designated as normal.

17. The system of claim 15, comprising:
a handheld device including a left directional microphone, a center directional microphone, and a right directional microphone,
the non-transitory computer readable memory comprising instructions that when executed on the processor:
during the operating period of time:
capture a left audio sample from the left directional microphone, generate a left spectral representation of the left audio sample,
capture a center audio sample from the center directional microphone, generate a center spectral representation of the center audio sample,
capture a right audio sample from the right directional microphone mounted in the handheld device,
determine that at least one of the left, center, and right spectral representations matches the first spectral representation, and
visually indicate on the handheld device which of the left, center, and right spectral representations that match the first spectral representation.

18. The system of claim 15, comprising:
a vibration sensor coupled to a specific mechanical device under the array of microphones;
the non-transitory computer readable memory comprising instructions that when executed on the processor:
during the training period of time:
generate a second spectral representation from the vibration sensor, and
generate a training data record including the second spectral representation and a normal designation.

19. The system of claim 15, the non-transitory computer readable memory comprising instructions that when executed on the processor:
during a second training period of time:
train the machine learning model with the first spectral representation designated as normal.

20. The system of claim 15, the non-transitory computer readable memory comprising instructions that when executed on the processor:
during a setup period of time:
clone the trained machine learning model to provide a unique trained machine learning model for each microphone in the array of microphones.
